(19) United States
(12) Patent Application Publication
(10) Pub. No.: US 2014/0306858 A1
(43) Pub. Date: Oct. 16, 2014

(54) BROADBAND ANTENNA AND AN ANTENNA ASSEMBLY

(71) Applicant: QUANTA COMPUTER INC., Tao Yuan Hsien (TW)

(72) Inventors: Chin-Lung TSAI, Chiayi City (TW); Men-Hsueh TSAI, New Taipei City (TW)

(73) Assignee: QUANTA COMPUTER INC., Tao Yuan Hsien (TW)

(21) Appl. No.: 14/104,171

(22) Filed: Dec. 12, 2013

(30) Foreign Application Priority Data
Apr. 16, 2013 (TW) 102113451

(51) Int. Cl. H01Q 9/14

(52) U.S. Cl. CPC H01Q 9/145
USPC 343/750

(57) ABSTRACT

A broadband antenna includes a grounding plane, a radiation unit which has first and second radiation components disposed adjacent to the grounding plane, and an impedance adjusting unit which is operable to adjust an impedance upon receipt of and according to a control signal. A length of a resonance path of the antenna is equal to an overall electrical length of from the first radiation component, the impedance adjusting unit, to the second terminal.

### CROSS-REFERENCE TO RELATED APPLICATION

This application claims priority of Taiwanese Application No. 102113451, filed on Apr. 16, 2013.

### BACKGROUND OF THE INVENTION

1. Field of the Invention

The invention relates to a broadband antenna, more particularly to a broadband antenna with dynamic adjustable impedance inputs.

2. Description of the Related Art

Referring to FIG. 1, a conventional diversity antenna disclosed by U.S. Pat. No. 6,483,463 including a first radiating component 11 and a second radiating component 12 that operate in the same frequency band. The drawbacks of the conventional diversity antenna lie in that, firstly, the input impedances at feed-in points 111, 121 of the first and second radiating components 11, 12 are fixed and cannot be adjusted according to different usage scenarios, and secondly, since the first and second radiating components 11, 12 are separate and non-planar, the conventional diversity antenna has greater manufacturing and assembling costs, higher defect rate due to the need for assembly, and is unsuitable for use in compact electronics, such as universal serial bus (USB) devices.

### SUMMARY OF THE INVENTION

Therefore, the object of the present invention is to provide a broadband antenna with adjustable input impedances.

Accordingly, a broadband antenna of the present invention includes a grounding plane, a radiation unit, and an impedance adjusting unit.

The grounding plane has an edge . The radiation unit includes a first radiation component and a second radiation component. The first radiation component has a feed-in point spaced apart from and disposed adjacent to the edge of the grounding plane. The second radiation component is spaced apart from the first radiation component and has a free end.

The impedance adjusting unit has a first terminal and a second terminal. The first terminal and the second terminal are electronically and respectively connected to the first radiation component and the second radiation component. The impedance adjusting unit is operable to adjust an impedance between the first terminal and the second terminal upon receipt of and according to a control signal.

A length of a resonance path of the broadband antenna is equal to an overall electrical length of from the first radiation component, the impedance adjusting unit, to the free end of the second radiation component.

Another object of the present invention is to provide an antenna assembly. The antenna assembly of the present invention includes a grounding plane and two broadband antennas.

The grounding plane has two edges. Each of the broadband antennas includes a radiation unit, an impedance adjusting unit and an input matching unit. The radiation units includes a first radiation component, which has a feed-in point spaced apart from and disposed adjacent to a respective one of the edges of the grounding plane, and a second radiation component, which is spaced apart from the first radiation component and has a free end. The impedance adjusting unit has a first terminal and a second terminal respectively connected to the first radiation component and the second radiation component. The impedance adjusting unit is operable to adjust an impedance between the first terminal and the second terminal upon receipt of and according to a control signal. The input matching unit includes an inductor having a first terminal adapted for receiving a radio frequency signal and a second terminal connected to the feed-in point of the first radiation component, and a capacitor having a first terminal connected to the second terminal of the second inductor and a second terminal connected to the grounding plane. A resonance path of each of the broadband antennas is an overall electrical length from the first radiation component, the impedance adjusting unit, to the free end of the second radiation component. The radiation units are mirror symmetrical to each other in respect to a line of symmetry, and are each separated from the line of symmetry. The two edges of the grounding plane are located on opposite sides of the line of symmetry.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional diversity antenna;

FIG. 2 is a schematic diagram of a broadband antenna according to the preferred embodiment of the present invention;

FIGS. 3 to 7 are circuit diagrams illustrating first to fifth implementations of an impedance adjusting unit of the broadband antenna according to the preferred embodiment;

FIG. 8 is a circuit diagram of an input matching unit of the broadband antenna according to the preferred embodiment;

FIG. 9 is a schematic diagram of an antenna assembly according to the preferred embodiment; and

FIG. 10 is a diagram of the voltage standing wave ratios (VSWR) measured for the antenna assembly of FIG. 9.

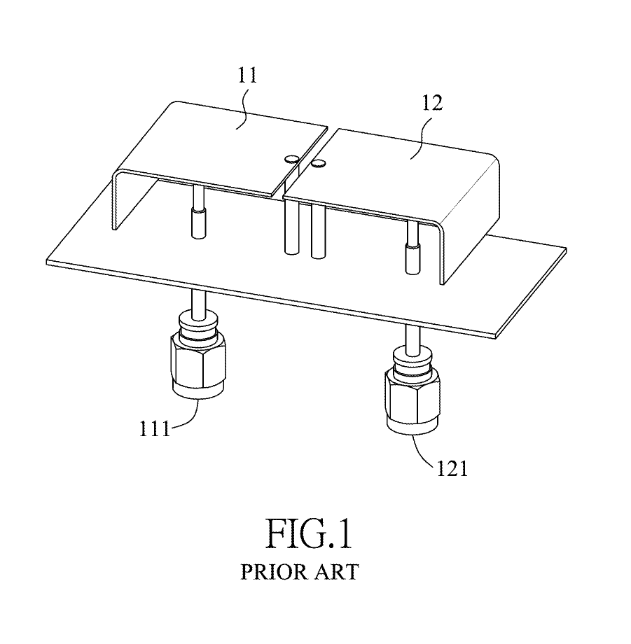

### DETAILED DESCRIPTION OF THE PREFERRED EMBODIMENT

Before the present invention is described in greater detail, it should be noted that like elements denoted by the same reference numerals throughout the disclosure.

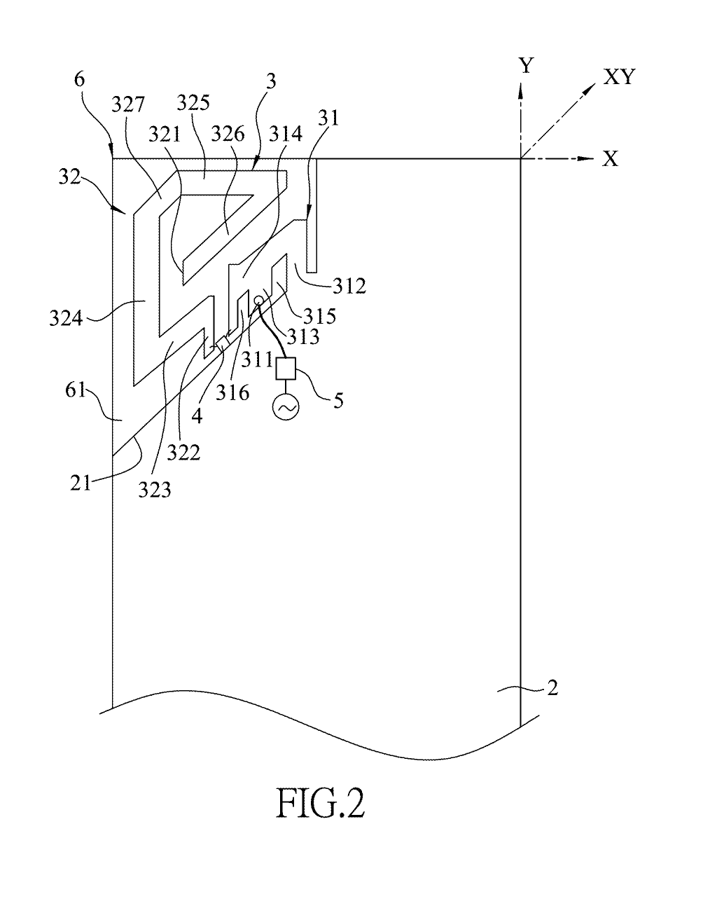

Referring to FIG. 2, a preferred embodiment of a broadband antenna according to the present invention includes a grounding plane 2, a radiation unit 3, an impedance adjusting unit 4, an input matching unit 5 and a substrate 6.

The grounding plane 2 provides a reference ground potential and has an edge 21 extending substantially in a first direction (XY).

The radiation unit 3 includes a first radiation component 31 and a second radiation component 32.

The first radiation component 31 has a signal feed-in point 311 spaced apart from and disposed adjacent to the edge 21 of the grounding plane 2 for transmitting and receiving a radio frequency (RF) signal, a short circuit arm 312 extending protrudingly from the grounding plane 2, a feeding arm 313 spaced apart from the short circuit arm 312 and having the feed-in point 311 disposed thereon, and a connecting arm 314. The short circuit arm. 312, the feeding arm. 313 and the connecting arm. 314 are connected and cooperatively form. an E shape with two openings 315, 316 facing the edge 21 of the grounding plane 2. The feeding arm 313 is disposed between the two openings 315, 316.

The second radiation component 32 is a long and bending, and is spaced apart from the first radiation component 31. The second radiation component 32 has a free end 321, a connecting arm segment 322, a first segment 323, a second segment 324, a third segment 325, a fourth segment 326 and a fifth segment 327. The first segment 323 is connected to and forms a bend with the connecting arm segment 322, and extends substantially in the first direction (XY). The second segment 324 is connected to and forms a bend the first segment 323, and extends substantially in a second direction (Y) that is non-parallel with the first direction (XY). The connecting arm segment 322, the first segment 323 and the second segment 325 cooperatively form a Z shape.

The third segment 325 is connected to the second segment 324 and extends substantially in a third direction (X) perpendicular to the second direction (Y).

The fourth segment 326 is connected to and forms a bend with the third segment 325, and extends substantially in the first direction (XY) towards the second segment 324 in a manner that the fourth segment 326 is disposed between the third segment 325 and the first radiation component 31 and spaced apart from the first radiation component 31, that a projection of the fourth segment 326 on an imaginary plane perpendicular to the second direction (Y) at least partially overlaps a projection of the third segment 325 on the imaginary plane, and that capacitive coupling is generated between the fourth segment 326 and the first radiation component 31. The fifth segment 327 extends substantially in the first direction (XY) and interconnects the second segment 324 and the third segment 325.

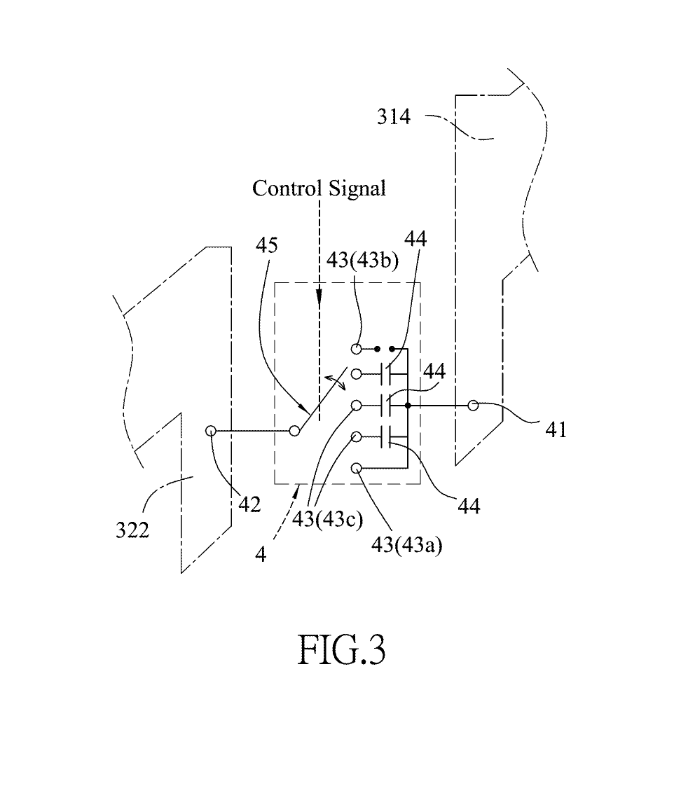

With further reference to FIG. 3, the impedance adjusting unit 4 includes a first terminal 41, and a second terminal 42 that are respectively connected to the connecting arm 314 of the first radiation component 31 and the connecting arm segment 322 of the second radiation component 32. The impedance adjusting unit 4 is operable to adjust an impedance between the first terminal 41 and the second terminal 42 upon receipt of and according to a control signal. A resonance path of the broadband antenna is an electrical length of from the first radiation component 31, the impedance adjusting unit 4 to the free end 321 of the second radiation component 32.

The impedance adjusting unit 4 further has N number of switching points 43, N-2 number of reactance components 44 and a switching arm 45, where N is a positive integer greater than 2. Two of the switching points 43a, 43b respectively forma short circuit and an open circuit with the first terminal 41. Each of the reactance components 44 is one of a fixed capacitor, a fixed inductor, a variable capacitor and a variable inductor, and has a first end electrically connected to the first terminal 41 and a second end electrically connected to a respective one of the switching points 43c other than said two of the switching points 43a, 43b. The switching arm 45 has a fixed end that is electrically connected to the second terminal 42 and a switching end that is operable to be electrically connected to one of the switching points 43 according to the control signal.

FIGS. 3 to 7 illustrate various exemplary implementations of the impedance adjusting unit 4 according to the preferred embodiment.

FIG. 3 illustrates a first implementation of the impedance adjusting unit 4 according to the preferred embodiment, where N=5, i.e., there are five switching points 43 and three reactance components 44 in this embodiment. Herein, each reactance component 44 is a fixed capacitor.

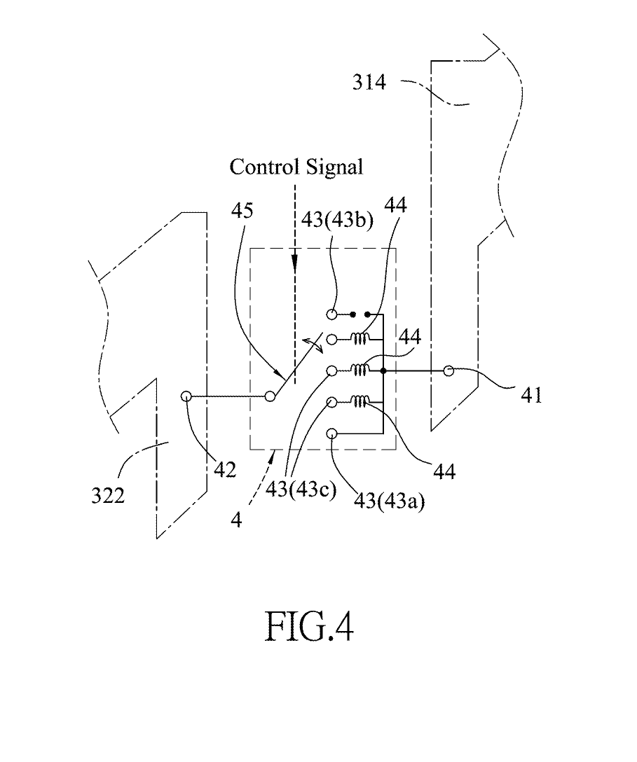

FIG. 4 illustrates a second implementation of the impedance adjusting unit 4 according to the embodiment, which differs from the first implementation in that each reactance component 44 is a fixed inductor.

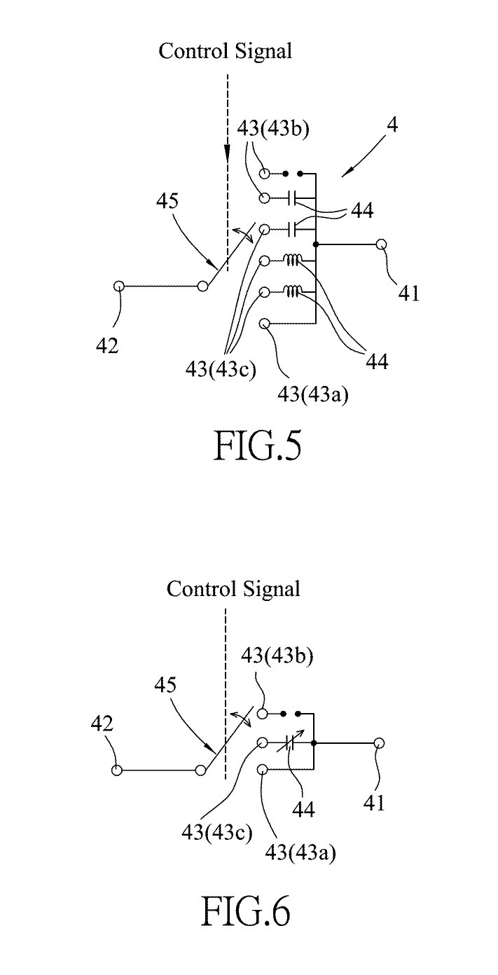

FIG. 5 illustrates a third implementation of the impedance adjusting unit 4 according to the preferred embodiment, which differs from the first embodiment in that N=6, and that out of the N-2 number (i.e., four) of reactance components 44, two are fixed inductors and two are fixed capacitors.

FIG. 6 illustrates a fourth implementation of the impedance adjusting unit 4 according to the preferred embodiment, which differs the first implementation in that N=3, and that the N-2 (i.e., one) reactance component 44 is a variable capacitor.

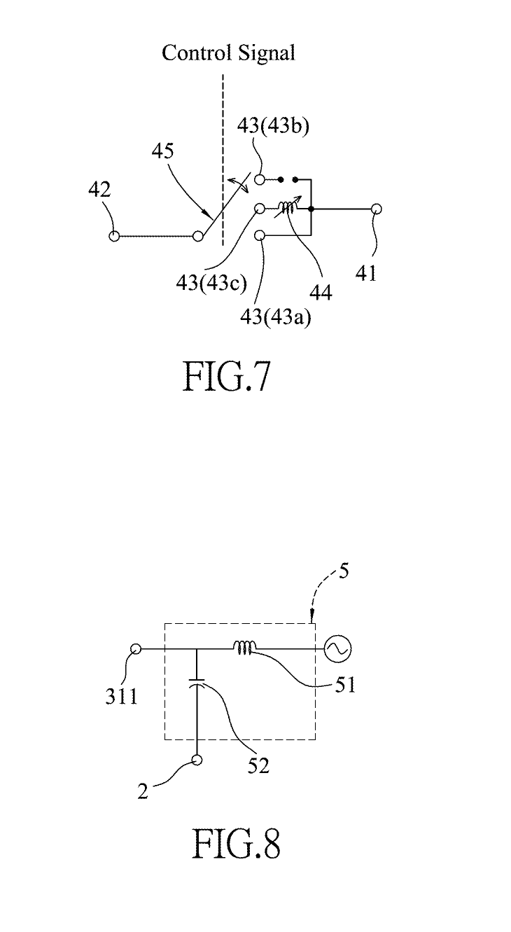

FIG. 7 illustrates a fifth implementation of the impedance adjusting unit 4 according to the preferred embodiment, which differs from the fourth implementation in that the reactance component 44 is a variable inductor.

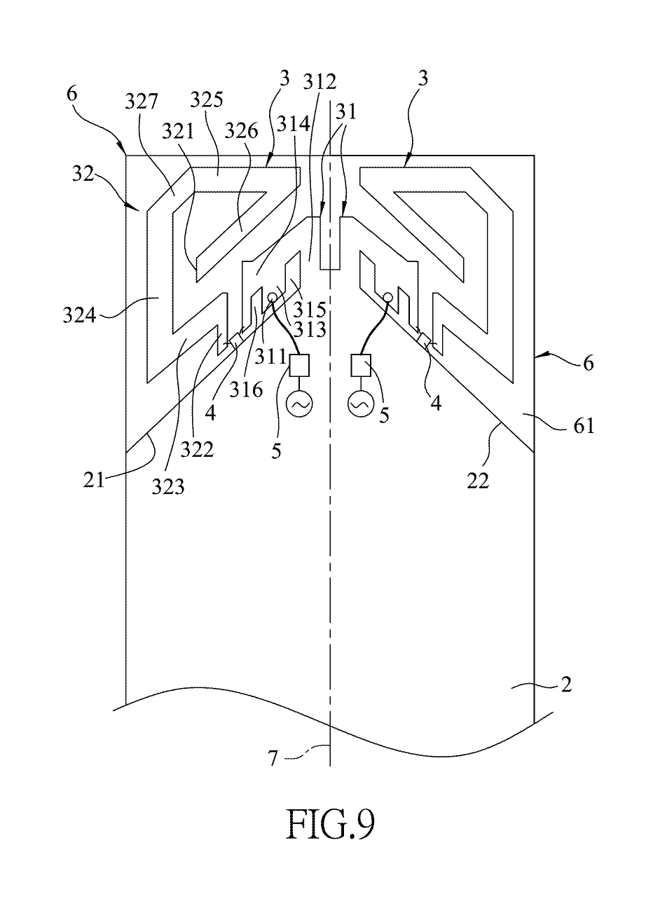

Referring to FIG. 8, the input matching unit 5 includes an inductor 51 and a capacitor 52. The inductor 51 has a first terminal adapted for receiving a radio frequency signal and a second terminal connected to the signal feed-in point 311. The capacitor 52 includes a first terminal electrically connected to the second terminal of the inductor 51 and a second terminal electrically connected to the grounding plane 2.

Referring back to FIG. 2, the substrate 6 has a surface 61 on which the grounding plane 2 and the radiation unit 3 are disposed. For example, the substrate 6 may be a glass fiber panel, and the grounding plane 2 and the radiation unit 3 are made by etching a copper layer adhered to the surface 61 of the substrate 6.

Referring to FIG. 9, an antenna assembly according to the preferred embodiment of the present invention includes a grounding plane 2, and two antennas, each of which includes the radiation unit 3, the impedance adjusting unit 4 and the input matching unit 5 as described above. The grounding plane 2 has two edges 21, 22. The first radiation components 31 of the radiation units 3 are respectively spaced apart from and disposed adjacent to the edges 21, 22. The two radiation units 3 are mirror symmetrical to each other in respect to a line of symmetry and are each separated from the line symmetry. The two edges 21, 22 are located on opposite sides of the line of symmetry.

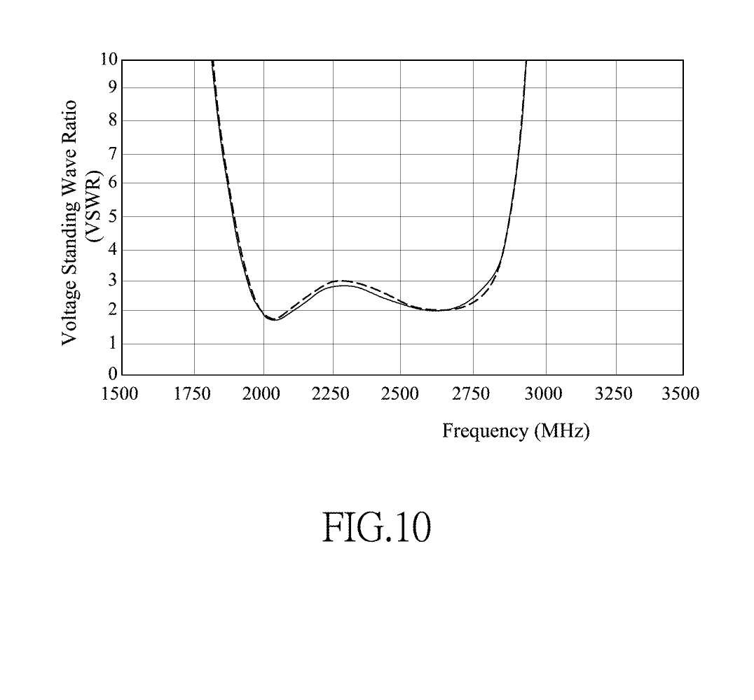

FIG. 10 is a diagram of the voltage standing wave ratios (VSWR) of the antenna assembly shown in FIG. 9. The VSWRs are measured at the first terminals (see FIG. 8) of the inductors 51 of the two input matching units 5. The diagram indicates that the antenna assembly operates with dual mode resonance, and that each radiation unit 3 with its corresponding input matching unit 5 has a 850 MHz broadband for VSWR<3.

In sum, the present invention offers the following advantages:
1. The input impedance of the radiation unit 3 at the feed-in point 311 is adjustable through the impedance adjusting unit 4. Therefore, the broadband antenna and the antenna assembly of this invention are flexible for applications under different conditions.

2. The grounding plane 2 and the radiation unit 3 are both planar, and the impedance adjusting unit 4 and the input matching unit 5 can be attached to the surface 61 of the substrate 6 rapidly and precisely through surface mounting techniques. Therefore, the costs of manufacturing and assembling are lower as compared with the prior art, the yield rate is higher, and the resultant products are suitable for thin, compact electronic products.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A broadband antenna comprising:
a grounding plane having an edge;
a radiation unit including
a first radiation component, which has a feed-in point spaced apart from and disposed adjacent to said edge of said grounding plane, and
a second radiation component, which is spaced apart from said first radiation component and has a free end; and
an impedance adjusting unit having a first terminal and a second terminal that are respectively connected to said first radiation component and said second radiation component, said impedance adjusting unit being operable to adjust an impedance between said first terminal and said second terminal upon receipt of and according to a control signal;
wherein a length of a resonance path of said broadband antenna is equal to an overall electrical length of from said first radiation component, said impedance adjusting unit, to said free end of said second radiating component.

2. The broadband antenna of claim 1, wherein said impedance adjusting unit further has:
N number of switching points, where N is a positive integer greater than 2, two of said switching points respectively forming a short circuit and an open circuit with said first terminal;
N-2 number of reactance components, each of which is one of a fixed capacitor, a fixed inductor, a variable capacitor and a variable inductor, and has a first end electrically connected to said first terminal and a second end electrically connected to a respective one of said switching points other than said two of said switching points; and
a switching arm, which has a fixed end that is electrically connected to said second terminal and a switching end that is operable to be electrically connected to one of said switching points according to the control signal.

3. The broadband antenna of claim. 1, wherein said first radiation component further has:
a short circuit arm extending protrudingly from said grounding plane;
a feeding arm spaced apart from said short circuit arm and having said feed-in point disposed thereon; and
a connecting arm connected to said short circuit arm, said feeding arm and said first terminal.

4. The broadband antenna of claim 3, wherein said short circuit arm, said feeding arm and said connecting arm cooperatively form an E shape with two openings facing said edge of said grounding plane, said feeding arm being disposed between said openings.

5. The broadband antenna of claim 1, wherein said edge of said grounding plane extends substantially in a first direction, said second radiation component further having:
a connecting arm segment electrically connected to said second terminal;
a first segment connected to and forming a bend with said connecting arm segment, and extending substantially in the first direction;
a second segment connected to and forming a bend with said first segment, and extending substantially in a second direction that is non-parallel with the first direction;
a third segment connected to said second segment, and extending substantially in a third direction that is substantially perpendicular to the second direction;
a fourth segment connected to and forming a bend with said third segment, having said free end, and extending substantially in the first direction toward said second segment such that said fourth segment is disposed between said second segment and said first radiation component and such that a projection of said fourth segment on an imaginary plane perpendicular to the second direction at least partially overlaps a projection of said third segment on the imaginary plane.

6. The broadband antenna of claim 5, wherein said second radiation component further has:
a fifth segment extending substantially in the first direction, and interconnecting said second segment and said third segment.

7. The broadband antenna of claim 5, wherein said connecting arm segment, said first segment and said second segment cooperatively form a Z shape.

8. The broadband antenna of claim 1, further comprising an input matching unit that includes:
an inductor having a first terminal adapted for receiving a radio frequency signal, and a second terminal connected to said feed-in point of said first radiation component; and
a capacitor having a first terminal connected to said second terminal of said second inductor, and a second terminal connected to said grounding plane.

9. An antenna assembly comprising:
a grounding plane having two edges;
two antennas, each including
a radiation unit that includes
a first radiation component, which has a feed-in point spaced apart from and disposed adjacent to a respective one of said edges of said grounding plane, and
a second radiation component, which is spaced apart from said first radiation component and has a free end,
an impedance adjusting unit that has a first terminal and a second terminal respectively connected to said first radiation component and said second radiation component, said impedance adjusting unit being operable to adjust an impedance between said first terminal and said second terminal upon receipt of and according to a control signal,
an input matching unit that includes
an inductor having a first terminal adapted for receiving a radio frequency signal and a second terminal connected to said feed-in point of said first radiation component, and
a capacitor having a first terminal connected to said second terminal of said second inductor and a second terminal connected to said grounding plane,
wherein a resonance path of each of said broadband antennas is an overall electrical length from said first radiation component, said impedance adjusting unit, to said free end of said second radiating component;
wherein said radiation units of said antennas are mirror symmetrical to each other in respect to a line of symmetry and are each separated from the line of symmetry, said two edges of said grounding plane being located on opposite sides of the line of symmetry.
